(19) United States
(12) Patent Application Publication
(10) Pub. No.: US 2003/0110064 A1
(43) Pub. Date: Jun. 12, 2003

(54) System and method of material management

(76) Inventors: Steve Tu, Taipei (TW); Pei-Huan Chung, Taipei (TW); Stan Chen, Taipei (TW); Yi-Ming Liao, Taipei (TW)

Correspondence Address: ROTHWELL, FIGG, ERNST & MANBECK, P.C., 1425 K STREET, N.W., SUITE 800, WASHINGTON, DC, 20005, US

(21) Appl. No.: 10/004,880

(22) Filed: Dec. 7, 2001

(51) Int. Cl. G06F 17/60

(52) U.S. Cl. 705/7

(57) ABSTRACT

A system and a method of material management are proposed, which can be applied to a system for managing procurement and sale of materials and products, allowing materials to be received and issued in a first-in-first-out manner that, materials received at earlier material-receiving dates are prior to be issued for use, so that problems of material hoarding and expiring material validity can be eliminated. A user at a terminal device can provide material-receiving or material-issuing data required for conducting a material-receiving or material-issuing operation through the use of the material management system, in which two-way communication is established between the material management system and the user, allowing the user to realize a current material-receiving or material-issuing condition in real time.

### FIELD OF THE INVENTION

The present invention relates to systems and methods of material management and more particularly, to a system and a method of material management applied to a system for managing procurement and sale of materials and products, allowing materials to be processed in a first-in-first-out manner in real time, so that problems of material hoarding and expiring material validity can be eliminated.

### BACKGROUND OF THE INVENTION

A conventional material management system for receiving and issuing materials, as shown in FIG. 1, includes a receiving department 11, a handling department 12, and a delivering department 13. In receiving materials, the receiving department 11 receives data of the received materials and transmits the data to the handling department 12 so as to store the received materials in the handling department 12. In issuing materials, the delivering department 13 receives a material-issuing request and transmits the request to the handling department 12, allowing the handling department 12 to issue corresponding materials according to the request.

However, in practical use, the conventional material management system shown in FIG. 1 can not operate in a real-time material management mode, wherein received materials are not processed in a first-in-first-out manner, but instead, they are merely stored according to categories of the materials; this easily generates problems of material hoarding and expiring validity of the materials. Besides, since a remittance is conventionally made upon completely receiving the materials, financial straits are liable to occur. In the material issuing process, materials can only be issued according to material required quantities but not in an order following the receiving dates of the materials. As a result, first-in materials can not promise to be first-out utilized; this possibly a material pending problem, in which materials are expired with their validity and unable to be used, thereby resulting in undesirable waste of materials and capital costs. Therefore, how to develop an effective system and method of material management for processing materials in a first-in-first-out manner in real time, is a critical topic to investigate.

### SUMMARY OF THEE INVENTION

A primary objective of the present invention is to provide a system and a method of material management, which can be applied to a system for managing procurement and sale of materials and products, allowing materials to be processed in a first-in-first-out manner in real time, so that problems of material hoarding and expiring material validity can be eliminated.

According to the above and other objectives, the present invention proposes a novel system and a method of material management, which can be applied to a system for managing procurement and sale of materials and products, allowing materials to be received and issued in a first-in-first-out manner in real time, so that problems of material hoarding and expiring material validity can be eliminated.

The material management system of the invention comprises: at least one terminal device for allowing a user at the terminal device to transmit material-receiving data or material-issuing data to a network management server, wherein the terminal device has a browser for obtaining the material-receiving data or the material-issuing data from a material database of a material database server via the network management server; the network management server for receiving the material-receiving data or the material-issuing data transmitted from the user at the terminal device; wherein after receiving and integrating the material-receiving data or the material-issuing data from the terminal device, the network management server accesses material data of the material database of the material database server; wherein the network management server receives the material-receiving data or the material-issuing data from the material database of the material database server; and transmits the received data to the terminal device via a network; and the material database server having the material database required by the network management server.

Moreover, the network management server has a material management module that includes a material management program and a material management homepage. The material management module displays the material management homepage in the browser of the terminal device for allowing the user at the terminal device to provide and transmit material-receiving data or material-issuing data to the material management module of the network management server via the browser of the terminal device. After receiving and integrating the material-receiving data or the material-issuing data from the terminal device, the material management module executes the material management program, so as to conduct a material-receiving operation or a material-issuing operation and to access material data of the material database of the material database server via the material management module. The material management module receives the material-receiving data or the material-issuing data from the material database of the material database server, and the material management homepage of the material management module transmits the received data to the browser of the terminal device via a network.

The material management method of the invention can be applied to a material management system including material database servers, a network management server and terminal devices for proceeding a real-time material management of receiving and issuing materials.

The material management method comprises the steps of. (1) transmitting material-receiving data via a user at one of the terminal devices in a material-receiving form to the network management server through a network; (2) receiving and integrating the material-receiving forms via the network management server from the terminal devices, so as to initiate and establish connection with one of the material database servers that provides material-receiving data service according to types of the material-receiving data, wherein the material-receiving data are inputted to the material database server and stored in a material database of the material database server in an order of material-receiving dates; (3) transmitting the material-receiving data via the material database server from the material database to the network management server and to the terminal device via a network, so as to conduct two-way communication with the user at the terminal device, allowing the user to immediately realize a material-receiving status; (4) transmitting material-issuing data via a user at one of the terminal devices in a material-issuing form according to a material-issuing status to the network management server through Internet or intranet; (5) receiving and integrating the material-issuing forms from the terminal devices via the network management server, so as to initiate and establish connection with one of the material database servers that provides material-issuing data service according to types of the material-issuing data, for inputting the material-issuing data to the material database server; receiving the material-issuing data via the material database server, and inspecting material data in a material database thereof to issue materials in an order of material-receiving dates, so that a material with an earlier material-receiving date is prior to be issued, and a first-in-first-out mode of material management is proceeded in receiving and issuing materials; and (6) transmitting the material-issuing data via the material database server from the material database to the network management server and to the terminal device via a network, so as to conduct two-way communication with the user at the terminal device or a user at the network management server, allowing the user to immediately realize a material-issuing status. In the use of the system and method of material management of the invention, materials can be received and issued in a first-in-first-out manner that, materials received at earlier material-receiving dates are prior to be issued for use, so that problems of material hoarding and expiring material validity can be eliminated.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a schematic block diagram showing basic architecture of a conventional material management system;

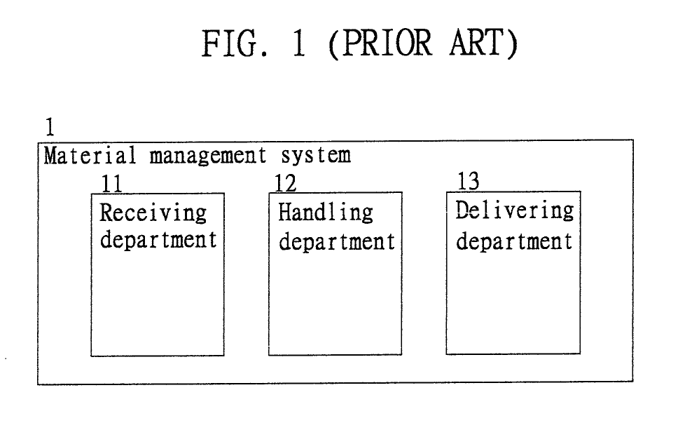

FIG. 2 is a schematic block diagram showing basic architecture of a material management system of the invention;

FIG. 3 is a schematic diagram showing data flow in operation of a material management method through the use of a material management system of the invention;

FIG. 4 is a schematic diagram showing a material-receiving process in operation of a material management method through the use of a material management system of the invention;

FIG. 5 is a schematic diagram showing a material-issuing process in operation of a material management method through the use of a material management system of the invention;

FIG. 6 is a schematic diagram illustrating a material management method in the use of a material management system of the invention;

FIG. 7 is a schematic diagram illustrating a step in more detail of storing material-receiving data in a material database of a material database server as shown in FIG. 6; and

FIG. 8 is a schematic diagram illustrating a step in more detail of issuing materials in a first-in-first-out mode as shown in FIG. 6.

### DETAILED DESCRIPTION OF THE PREFERRED EMBODIMENT

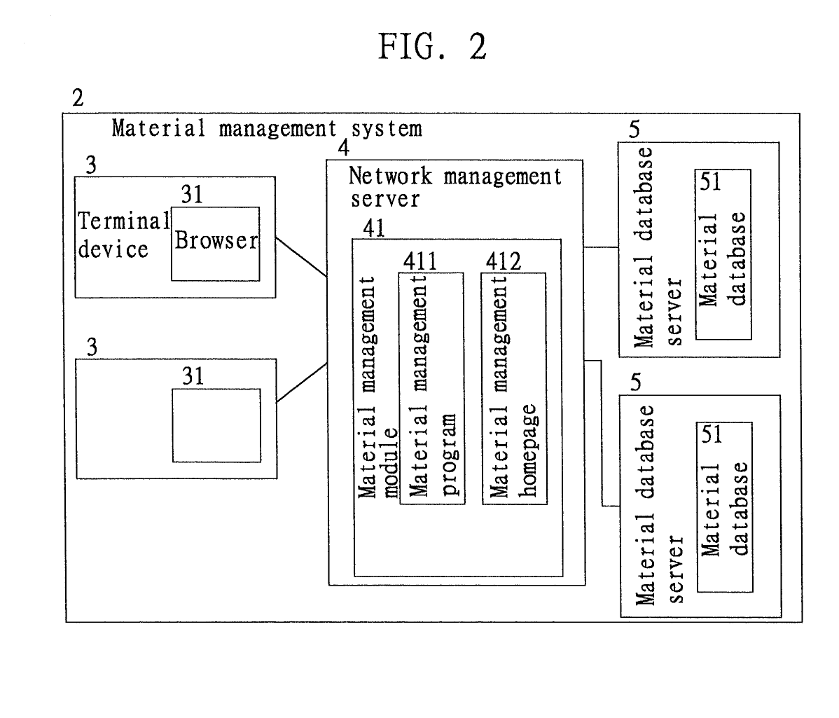

FIG. 2 illustrates basic architecture of a material management system of the invention. As shown in the drawing, the material management system 2 comprises terminal devices 3, a network management server 4 and material database servers 5. The terminal devices 3 are each provided with a browser 31. The network management server 4 includes a material management module 41 that contains a material management program 411 and a material management homepage 412. The material database servers 5 each contains a material database 51 required for the material management program 411 of the material management module 41. The material management module 41 of the network management server 4 displays the material management homepage 412 in the browser 31 of the terminal device 3, allowing a user of the browser 31 to provide material-receiving or material-issuing data that are transmitted to the material management module 41 of the network management server 4 by the browser 31 of the terminal device 3. After the material management module 41 receives and integrates the material-receiving or material-issuing data, it executes the material management program 411, which can conduct a material-receiving or material-issuing operation to access material data in the material database 51 of the material database server 5 via the material management module 41. After the material management module 41 receives the material data from the material database 51, the material management homepage 412 thereof can transmit the material data to the browser 31 of the terminal device 3 via a network. The browser 31, the material management program 411 and the material management homepage 412 can execute language of HTML, ASP, DHTML, XML, Java, VB, JavaScript or VB Script. The material database 51 of the material database server 5 can be a type of MS Access, MS SQL or ORACLE.

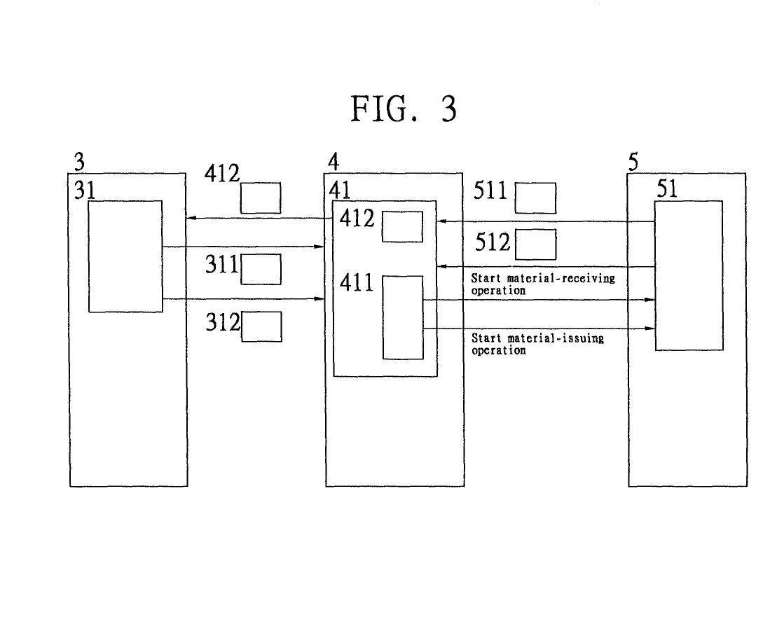

FIG. 3 illustrates data flow in operation of a material management method through the use of a material management system of the invention. As shown in the drawing, the material management module 41 of the network management module 4 can conduct a material-receiving or material-issuing operation. In a material-receiving operation, the material management module 41 displays the material management homepage 412 in the browser 31 of the terminal device 3, allowing a user of the browser 31 to provide material-receiving data, wherein the browser 31 transmits the material-receiving data via a material-receiving form 311 to the material management module 41 of the network management server 4. After the material management module 41 receives and integrates the material-receiving forms 311 from all the browsers 31, it executes the material management program 411, which initiates and establishes connection to a material database server 5 that can provide a material-receiving data service according to the material-receiving form 311 via the material management module 41. After the material database server 5 is initiated, the material as management program 411 inputs the material-receiving data into the associated database server 5 according to material type via the material management module 41. After the material database server 5 receives the inputted material-receiving data, it stores the received data in the material database 51 in an order of material-receiving dates. Upon receiving the material-receiving data for storage, the material database 51 firstly classifies the material-receiving data into categories according to vendor's names or codes, and then further classifies the material-receiving data of the same vendor's name or code into sub-categories according to material codes or types. In this case, the database server 5 can use a function of recording a current material-receiving condition of a vendor and write the classified material-receiving data into the material database 51, so as to update a most recent material-receiving file of the vendor in the material database 51. This file updating process can be set to be manually operated by a user, or automatically operated by the database server 5. File updating cycle can be set according to the practical conditions, e.g. once per day, once per forenoon and once per afternoon in one day, or once per 6 hours. The material database server 5 transmits the processed material-receiving data of the material database 51 via a form 511 to the material management module 41 of the network management server 4. The material management module 41 in turn transmits the processed data to a user of the network management server 4 or to the browser 31 of the terminal device 3 through a network, so as to establish two-way communication with the user of the terminal device 3 or the network management server 4, allowing the user to realize the current status of the material-receiving operation in real time.

In conducting a material-issuing operation, a user of the browser 31 of the terminal device 3 transmits material-issuing data via a material-issuing form 312 from the terminal device 3 to the material management module 41 of the network management server 4. The material management module 41 is used to receive the material-issuing data from the browser 31 of the terminal device 3. Alternatively, a user of the network management server 4 can directly transmit the material-issuing data to the material management module 41 of the network management server 4. After the material management module 41 receives and integrates the material-issuing forms 312 from all the terminal devices 3, it executes the material management program 411 according to the material-issuing forms 312 to initiate and establish connection with a material database server 5 that can provide a material-issuing data service. After the material database server 5 is initiated, the material management program 411 inputs the material-issuing data into the associated material database sever 5 according to material type, so as to access material data in the material database 51 of the material database server 5 for proceeding the material-issuing operation. The material database server 5 firstly examines the material data of the material database 51, and performs the material-issuing operation in a first-in-first-out manner to issue materials according to a material-issuing request; that is, materials received earlier are prior to be issued. The material database server 5 transmits the material-issuing data of the material database 51 via a form 512 to the material management module 41 of the network management server 4. The network management server 4 transmits the data to the user of the network management server 4 or to the browser 31 of the terminal device 3 via a network, so as to establish immediate two-way communication with the user of the terminal device 3 or the network management server 4, allowing the user to realize the current status of the material-issuing operation. After the material database server 5 receives the material-receiving data, it automatically starts a function of inspecting material stocks and accordingly provides a stock list of available vendors. The material database server 5 automatically initiates a first-in-first-out function for issuing materials according to the stock list of the vendors in a manner that, materials received earlier from a vendor are prior to be issued; this can therefore reduce the occurrence of expiring validity of materials and material hoarding.

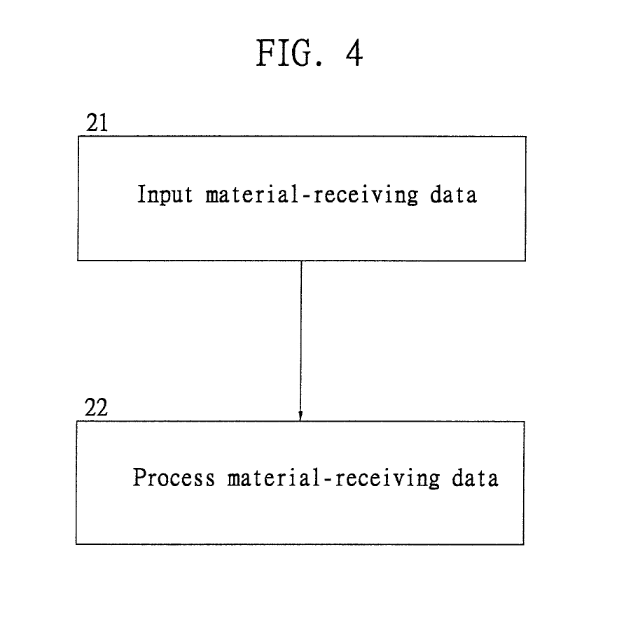

FIG. 4 illustrates a material-receiving process in operation of a material management method through the use of a material management system of the invention. As shown in the drawing, first, in step 21, when a material-receiving operation is initiated, the material management module 41 of the network management server 4 displays the material management homepage 412 in the browser 31 of the terminal device 3, allowing a user of the browser 31 to provide material-receiving data. The browser 31 transmits the material-receiving data via a material-receiving form 311 to the material management module 41 of the network management server 4. Thereafter, step 22 is followed.

In step 22, in conducting the material-receiving operation, after the material management module 41 of the network management server 4 receives and integrates the material-receiving forms 311 from all the terminal devices 3, it executes the material management program 411, which initiates and establishes connection with a material database server 5 that can provide a material-receiving data service according to the material-receiving forms 311 via the material management module 41. After the material database server 5 is initiated, the material management program 411 inputs the material-receiving data into the associated database server 5 according to material type via the material management module 41. After the material database server 5 receives the material-receiving data, it stores the received data in an order of material-receiving dates in the material database 51 thereof The material database 51 classifies the material-receiving data into categories according to vendor's names and codes, and then further classifies the material-receiving data of the same vendor's name and code into sub-categories according to material codes and types. The database server 5 can use a function of recording a current material-receiving condition of a vendor and write the classified material-receiving data into the material database 51, so as to update a most recent material-receiving file of the vendor in the material database 51. The file updating process can be set to be manually operated by a user, or automatically operated by the material database server 5. File updating cycle can be set according to the practical conditions, e.g. once per day, once per forenoon and once per afternoon in one day, or once per 6 hours. The material database server 5 transmits the processed material-receiving data of the material database 51 via a form 511 to the material management module 41 of the network management server 4, which then transmits the processed data to a user of the network management server 4 or to the browser 31 of the terminal device 3 via a network, so as to establish two-way communication with the user of the terminal device 3 or the network management server 4, allowing the user to realize the current status of the material-receiving operation.

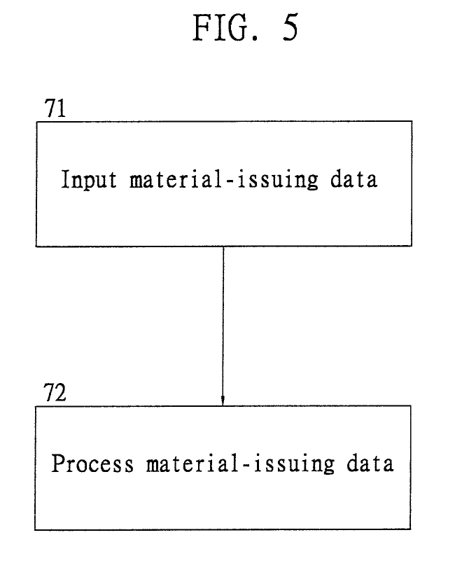

FIG. 5 illustrates a material-issuing process in operation of a material management method through the use of a material management system of the invention. As shown in the drawing, first, in step 71, when a material-issuing operation is initiated, according to a material-issuing status, a user of the browser 31 of the terminal device 3 transmits material-issuing data via a material-issuing form 312 from the terminal device 3 to the material management module 41 of the network management server 4. The material management module 41 is used for receiving the material-issuing data from the browser 31 of the terminal device 3. Alternatively, a user of the network management server 4 can directly transmit the material-issuing data via a form 413 to the material management module 41 of the network management server 4. Thereafter, step 72 is followed.

In step 72, in conducting the material-issuing operation, after the material management module 41 of the network management server 4 receives and integrates the material-issuing forms 312 from all the terminal devices 3, it execute the material management program 411 to initiate and establish connection with a material database server 5 that can provide a material-issuing data service according to the material-issuing forms 312. After the material database server 5 is initiated, the material management program 411 inputs the material-issuing data into the associated material database sever 5 to access material data in the material database 51 of the database server 5 for proceeding the material-issuing operation. The material database server 5 examines the material data of the material database 51 and performs the material-issuing operation in a first-in-first-out manner to issue materials; that is, materials received earlier are prior to be issued. The material database server 5 transmits the material-issuing data of the material database 51 via a form 512 to the material management module 41 of the network management server 4, which then transmits the data to a user of the network management server 4 or to the browser 31 of the terminal device 3 via a network, so as to establish immediate two-way communication with the user of the terminal device 3 or the network management server 4, allowing the user to realize the current status of the material-issuing operation. After the material database server 5 receives the material-issuing data, it automatically starts a function of inspecting material stocks, and accordingly provides a stock list of available vendors. The material database server 5 automatically initiates a first-in-first-out function for issuing materials in an order of material-receiving dates according to the stock list of the vendors in a manner that, materials received earlier from a vendor are prior to be issued; this therefore reduces the occurrence of material hoarding and expiring validity of materials.

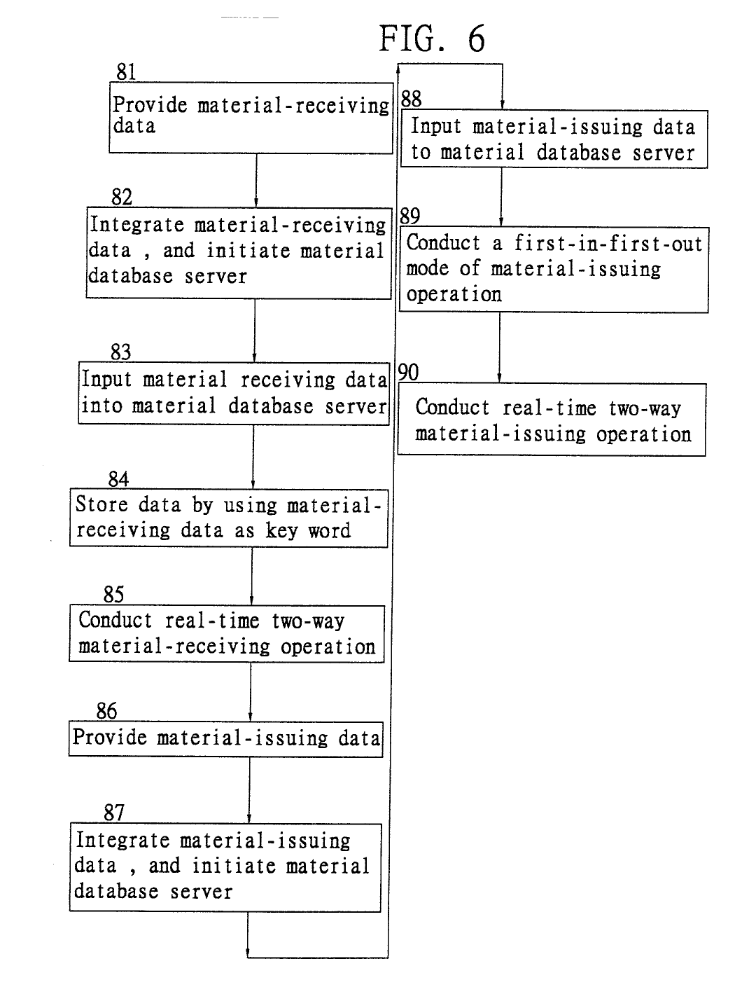

FIG. 6 illustrates a material management method in the use of a material management system of the invention. As shown in the drawing, first, in step 81, the material management module 41 of the network management server 4 displays the material management homepage 412 in the browser 31 of the terminal device 3, allowing a user of the browser 31 to provide material-receiving data. The browser 31 transmits the material-receiving data via a material-receiving form 311 to the material management module 41 of the network management server 4. Thereafter, step 82 is followed.

In step 82, after the material management module 41 of the network management server 44 receives and integrates the material-receiving forms 311 from all the terminal devices 3, it executes the material management program 411 to initiate and establish connection with a material database server 5 that can provide a material-receiving data service via the material management module 41 according to the material-receiving forms 311. Thereafter, step 83 is followed.

In step 83, after the material database server 5 is initiated, the material management program 411 inputs the material-receiving data into the associated database server 5 according to material type via the material management module 41. Thereafter, step 84 is followed.

In step 84, after the material database server 5 receives the material-receiving data, it stores the material-receiving data in the material database 51 thereof in an order of material-receiving dates. Thereafter, step 85 is followed.

In step 85, in conducting immediate two-way material-receiving operation, the material database server 5 transmits the processed material-receiving data of the material database 51 via a form 511 to the material management module 41 of the network management server 4, which then transmits the processed data to a user of the network management server 4 or to the browser 31 of the terminal device 3 via a network, so as to establish two-way communication with the user of the terminal device 3 or the network management server 4, allowing the user to realize the current status of the material-receiving operation. Thereafter, step 86 is followed.

In step 86, according to a material-issuing status, a user of the browser 31 of the terminal device 3 transmits material-issuing data via a material-issuing form 312 from the terminal device 3 to the material management module 41 of the network management server 4. The material management module 41 is used for receiving the material-issuing data from the browser 31 of the terminal device 3. Alternatively, a user of the network management server 4 can directly transmit the material-issuing data via a form 413 to the material management module 41 of the network management server 4. Thereafter, step 87 is followed.

In step 87, after the material management module 41 of the network management server 4 receives and integrates the material-issuing forms 312 from all the terminal devices 3, it executes the material management program 411 to initiate and establish connection with a material database server 5 that can provide a material-issuing data service according to the material-issuing forms 312. Thereafter, step 88 is followed.

In step 88, after the material database server 5 is initiated, the material management program 411 inputs the material-issuing data into the associated material database sever 5 according to material type, so as to access material data in the material database 51 of the material database server 5 for proceeding the material-issuing operation. Thereafter, step 89 is followed.

In step 89, after the material database server 5 receives the material-issuing data, it inspects the material data of the database 51 and performs the material-issuing operation in a first-in-first-out manner to issue materials according to material-receiving dates; that is, materials received earlier are prior to be issued. This therefore reduces the occurrence of material hoarding and expiring material validity. Thereafter, step 90 is followed.

In step 90, in conducting immediate two-way communication, the material database server 5 transmits the processed material-receiving data of the material database 51 via a form 512 to the material management module 41 of the network management server 4, which then transmits the processed data to a user of the network management server 4 or to the browser 31 of the terminal device 3 via a network, so as to establish immediate two-way communication with the user of the terminal device 3 or the network management server 4, allowing the user to realize the current status of the material-issuing operation.

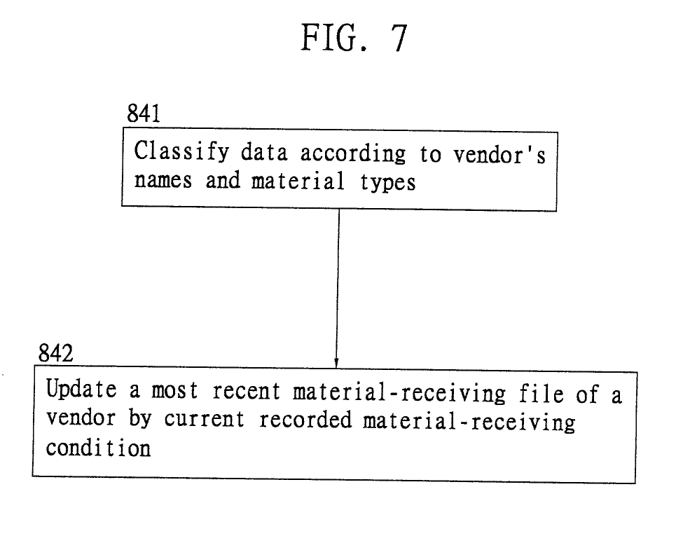

FIG. 7 illustrates a step in more detail of storing material-receiving data in a material database of a material database server as shown in FIG. 6. As shown in the drawing, first, in step 841, after the material database server 5 receives the material-receiving data, it classifies the material-receiving data into categories according to vendor's names and codes, and then further classifies the material-receiving data of the same vendor's name and code into sub-categories according to material codes and types. Thereafter, step 842 is followed.

In step 842, the database server 5 uses a function of recording a current material-receiving condition of a vendor and writes the classified material-receiving data into the material database 51, so as to update a most recent material-receiving file of the vendor in the material database 51. The file updating process can be set to be manually operated by a user, or automatically operated by the database server 5. File updating cycle can be set according to the practical conditions, e.g., once per day, once per forenoon and once per afternoon in one day, or once per 6 hours.

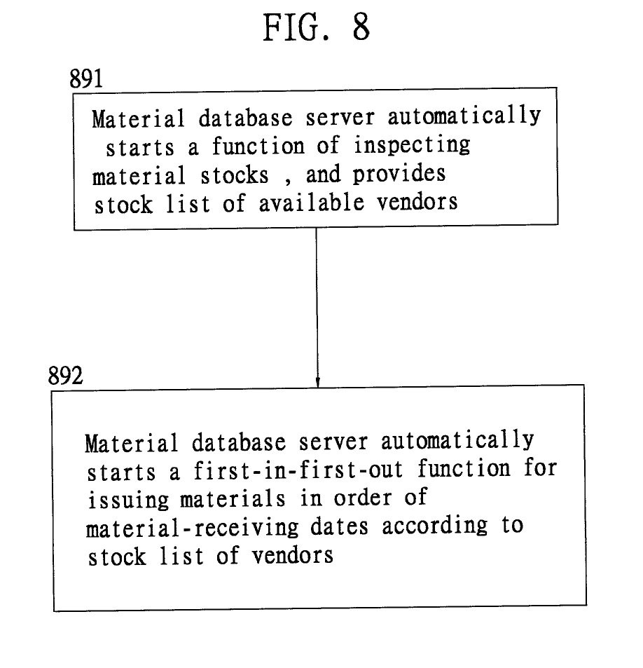

FIG. 8 illustrates a step in more detail of issuing materials in a first-in-first-out mode as shown in FIG. 6. As shown in the drawing, first, in step 891, after the material database server 5 receives the material-issuing data, it automatically starts a function of inspecting material stocks and according provides a stock list of available vendors. Thereafter, step 892 is followed.

In step 892, the material database server 5 automatically initiates a first-in-first-out function for issuing materials in an order of material-receiving dates according to the stock list of the vendors from the step 892 in a manner that, materials received earlier from a vendor are prior to be issued, so as to reduce the occurrence of material hoarding and expiring material validity.

In view of the above embodiments, the system and method of material management of the invention can be applied to a system for managing procurement and sale of materials and products, allowing materials to be received and issued in a first-in-first-out manner that, materials received at earlier material-receiving dates are prior to be issued for use, so that problems of material hoarding and expiring material validity can be eliminated. A user at a terminal device can provide material-receiving or material-issuing data required for conducting a material-receiving or material-issuing operation through the use of the material management system, in which two-way communication is established between the material management system and the user, allowing the user to realize a current material-receiving or material-issuing condition in real time.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A material management method, for being applied to a material management system including material database servers, a network management server and terminal devices for proceeding a real-time material management of receiving materials; the method comprising the steps of:
(1) transmitting material-receiving data via a user at one of the terminal devices in a material-receiving form to the network management server through a network; and
(2) receiving and integrating the material-receiving forms via the network management server from the terminal devices, so as to initiate and establish connection with one of the material database servers that provides material-receiving data service according to types of the material-receiving data, wherein the material-receiving data are inputted to the material database server and stored in a material database of the material database server in an order of material-receiving dates.

2. The material management method of claim 1, wherein the step (2) further comprises the steps of:
(2-1) classifying the received material-receiving data via the material database server into categories according to vendor's names and codes, and further classifying the material-receiving data of a same vendor's name and code into sub-categories according to material codes and types; and
(2-2) writing the classified material-receiving data into the material database via the material database server by using a function of recording a current material-receiving condition of a vendor, and updating a most recent material-receiving file of the vendor in the material database, wherein an operation mode and cycle time for updating the file are set according to practical conditions.

3. The material management method of claim 1, further comprising a step of:
(3) transmitting the material-receiving data via the material database server from the material database to the network management server and to the terminal device via a network, so as to conduct two-way communication with the user at the terminal device, allowing the user to immediately realize a material-receiving status.

4. The material management method of claim 1, further comprising the steps of:
(3) transmitting material-issuing data via the user at the terminal device according to a material-issuing status in a material-issuing form to the network management server through Internet or intranet; and
(4) receiving and integrating the material-issuing forms from the terminal devices via the network management server, so as to initiate and establish connection with one of the material database servers that provides material-issuing data service according to types of the material-issuing data, for inputting the material-issuing data to the material database server; receiving the material-issuing data via the material database server, and inspecting material data in a material database thereof to issue materials in an order of material-receiving dates, so that a material with an earlier material-receiving date is prior to be issued, and a first-in-first-out mode of material management is proceeded in receiving and issuing materials.

5. The material management method of claim 4, wherein the first-in-first-out mode of material management in issuing materials comprises the steps of:
(1) receiving the material-issuing data via the material database server, and automatically initiating a function of inspecting material stocks, so as to provide a stock list of available vendors; and
(2) automatically initiating a first-in-first-out function for issuing materials in an order of material-receiving dates via the material database server according to the stock list of the vendors, in a manner that a material with an earlier material-receiving date is prior to be issued.

6. The material management method of claim 1, wherein each of the material database servers includes a material database, the network management server has a material management module that includes a material management program and a material management homepage, and each of the terminal devices includes a browser.

7. The material management method of claim 6, wherein the material management module displays the material management homepage in the browser of the terminal device for allowing the user at the terminal device to provide and transmit the material-receiving data to the material management module of the network management server via the browser of the terminal device; after receiving and integrating the material-receiving data from the terminal device, the material management module executes the material management program, so as to conduct a material-receiving operation and to access material data of the material database of the material database server via the material management module; the material management module receives the material-receiving data from the material database of the material database server, and the material management homepage of the material management module transmits the received data to the browser of the terminal device via a network.

8. A material management method, for being applied to a material management system including material database servers, a network management server and terminal devices for proceeding a real-time material management of issuing materials; the method comprising the steps of:
(1) transmitting material-issuing data via a user at one of the terminal devices in a material-issuing form according to a material-issuing status to the network management server through Internet or intranet; and
(2) receiving and integrating the material-issuing forms from the terminal devices via the network management server, so as to initiate and establish connection with one of the material database servers that provides material-issuing data service according to types of the material-issuing data, for inputting the material-issuing data to the material database server; receiving the material-issuing data via the material database server, and inspecting material data in a material database thereof to issue materials in an order of material-receiving dates, so that a material with an earlier material-receiving date is prior to be issued, and a first-in-first-out mode of material management is proceeded in receiving and issuing materials.

9. The material management method of claim 8, wherein the step (2) further comprises the steps of:
(2-1) receiving the material-issuing data via the material database server, and automatically initiating a function of inspecting material stocks, so as to provide a stock list of available vendors; and
(2-2) automatically initiating a first-in-first-out function for issuing materials in an order of material-receiving dates via the material database server according to the stock list of the vendors, in a manner that a material with an earlier material-receiving date is prior to be issued, and the first-in-first-out mode of material management is proceeded in receiving and issuing materials.

10. The material management method of claim 8, further comprising a step of:
(3) transmitting the material-issuing data via the material database server from the material database to the network management server and to the terminal device via a network, so as to conduct two-way communication with the user at the terminal device or a user at the network management server, allowing the user to immediately realize a material-issuing status.

11. The material management method of claim 8, wherein each of the material database servers includes a material database, the network management server has a material management module that includes a material management program and a material management homepage, and each of the terminal devices includes a browser.

12. The material management method of claim 11, wherein the material management module displays the material management homepage in the browser of the terminal device for allowing the user at the terminal device to provide and transmit the material-issuing data to the material management module of the network management server via the browser of the terminal device; after receiving and integrating the material-issuing data from the terminal device, the material management module executes the material management program, so as to conduct a material-issuing operation and to access material data of the material database of the material database server via the material management module; the material management module receives the material-issuing data from the material database of the material database server, and the material management homepage of the material management module transmits the received data to the browser of the terminal device via a network.

13. A material management system for being applied to a real-time material management system, comprising:
at least one terminal device for allowing a user at the terminal device to transmit material-receiving data or material-issuing data to a network management server, wherein the terminal device has a browser for obtaining the material-receiving data or the material-issuing data from a material database of a material database server via the network management server;
the network management server for receiving the material-receiving data or the material-issuing data transmitted from the user at the terminal device; wherein after receiving and integrating the material-receiving data or the material-issuing data from the terminal device, the network management server accesses material data of the material database of the material database server; wherein the network management server receives the material-receiving data or the material-issuing data from the material database of the material database server, and transmits the received data to the terminal device via a network; and
the material database server having the material database required by the network management server.

14. The material management system of claim 13, wherein the network management server has a material management module that includes a material management program and a material management homepage; the material management module displays the material management homepage in the browser of the terminal device for allowing the user at the terminal device to provide and transmit material-receiving data or material-issuing data to the material management module of the network management server via the browser of the terminal device; after receiving and integrating the material-receiving data or the material-issuing data from the terminal device, the material management module executes the material management program, so as to conduct a material-receiving operation or a material-issuing operation and to access material data of the material database of the material database server via the material management module; the material management module receives the material-receiving data or the material-issuing data from the material database of the material database server, and the material management homepage of the material management module transmits the received data to the browser of the terminal device via a network.

15. The material management system of claim 13, wherein the material database of the material database server is a type of MS Access.

16. The material management system of claim 13, wherein the material database of the material database server is a type of MS SQL.

17. The material management system of claim 13, wherein the material database of the material database server is a type of ORACLE.
